(19) United States
(12) Patent Application Publication
(10) Pub. No.: US 2026/0203865 A1
(43) Pub. Date: Jul. 16, 2026

(54) MULTI-FRAME PROCESSING (MFP) USING MACHINE LEARNING-BASED DEGHOSTING TRAINED WITH SYNTHETIC MOTION MAPS

(71) Applicant: Samsung Electronics Co., Ltd., Suwon-si (KR)

(72) Inventors: Weidi Liu, McKinney, TX (US); Abhiram Gnanasambandam, Frisco, TX (US); Nguyen Thang Long Le, Garland, TX (US); Hamid Rahim Sheikh, Allen, TX (US)

(21) Appl. No.: 19/282,974

(22) Filed: Jul. 28, 2025

Related U.S. Application Data
(60) Provisional application No. 63/745,722, filed on Jan. 15, 2025.

(51) Int. Cl. G06T 5/50; G06T 7/20

(52) U.S. Cl. CPC G06T 5/50; G06T 7/20; G06T 2207/20081; G06T 2207/20221

(57) ABSTRACT

A method includes obtaining, using at least one processing device of an electronic device, multiple image frames comprising a reference frame and multiple non-reference frames. The method also includes obtaining, using the at least one processing device, multiple motion maps, where each motion map is based on a comparison between the reference frame and a respective one of the non-reference frames. The method further includes generating, using the at least one processing device, multiple modified non-reference frames based on the motion maps. Generating the modified non-reference frames includes, for each non-reference frame, blending the non-reference frame and the reference frame based on the corresponding motion map associated with the non-reference frame. In addition, the method includes providing, using the at least one processing device, the reference frame and the modified non-reference frames to a blending network to generate a single image.

### CROSS-REFERENCE TO RELATED APPLICATION AND PRIORITY CLAIM

This application claims priority under 35 U.S.C. §119(e) to U.S. Provisional Ser. No. 63/745,722 filed on Jan. 15, 2025, which is hereby incorporated by reference in its entirety.

### TECHNICAL FIELD

This disclosure relates generally to image processing systems and processes. More specifically, this disclosure relates to multi-frame processing (MFP) using machine learning-based deghosting trained with synthetic motion maps.

### BACKGROUND

Many mobile electronic devices, such as smartphones and tablet computers, include cameras that can be used to capture still and video images. In some cases, electronic devices can capture multiple image frames of the same scene, such as at different exposure levels, and blend the image frames to produce a high dynamic range (HDR) image of the scene. The HDR image generally has a larger dynamic range than any of the individual image frames. These techniques are often referred to as multi-frame processing (MFP) techniques. Among other things, blending the image frames to produce the HDR image can help to incorporate greater image details into both darker regions and brighter regions of the HDR image while reducing noise.

### SUMMARY

This disclosure relates to multi-frame processing (MFP) using machine learning-based deghosting trained with synthetic motion maps.

In a first embodiment, a method includes obtaining, using at least one processing device of an electronic device, multiple image frames including a reference frame and multiple non-reference frames. The method also includes obtaining, using the at least one processing device, multiple motion maps, where each motion map is based on a comparison between the reference frame and a respective one of the non-reference frames. The method further includes generating, using the at least one processing device, multiple modified non-reference frames based on the motion maps. Generating the modified non-reference frames includes, for each non-reference frame, blending the non-reference frame and the reference frame based on the corresponding motion map associated with the non-reference frame. In addition, the method includes providing, using the at least one processing device, the reference frame and the modified non-reference frames to a blending network to generate a single image. A non-transitory machine-readable medium may contain instructions that when executed cause at least one processor of an electronic device to perform the method of the first embodiment.

In a second embodiment, an electronic device includes at least one processing device configured to obtain multiple image frames including a reference frame and multiple non-reference frames. The at least one processing device is also configured to obtain multiple motion maps, where each motion map is based on a comparison between the reference frame and a respective one of the non-reference frames. The at least one processing device is further configured to generate multiple modified non-reference frames based on the motion maps. To generate the modified non-reference frames, the at least one processing device is configured, for each non-reference frame, to blend the non-reference frame and the reference frame based on the corresponding motion map associated with the non-reference frame. In addition, the at least one processing device is configured to provide the reference frame and the modified non-reference frames to a blending network to generate a single image.

Any one or any combination of the following features may be used with the first or second embodiment. For each non-reference frame, the non-reference frame and the reference frame may be blended by selecting a first group of pixels from the non-reference frame based on the corresponding motion map (the first group of pixels associated with pixel locations in the non-reference frame that exhibit a lower degree of motion); selecting a second group of pixels from the reference frame based on the corresponding motion map (the second group of pixels associated with pixel locations in the non-reference frame that exhibit a higher degree of motion); and combining the first group of pixels and the second group of pixels to generate a respective one of the modified non-reference frames. The blending network may be trained by obtaining multiple sets of training frames (each set of training frames including a reference training frame and multiple non-reference training frames); generating synthetic motion maps; for each set of training frames, blending the reference training frame into the non-reference training frames based on at least one of the synthetic motion maps to generate modified non-reference training frames; and training the blending network using the reference training frames and the modified non-reference training frames. The synthetic motion maps may be generated, for each set of training frames, by generating a reference synthetic motion map; generating multiple temporary synthetic motion maps; and combining the reference synthetic motion map and the temporary synthetic motion maps to generate multiple final synthetic motion maps. For each set of training frames, the reference synthetic motion map may be used to generate the final synthetic motion maps for all non-reference training frames in the set of training frames, and different ones of the temporary synthetic motion maps may be used to generate different ones of the final synthetic motion maps for different non-reference training frames in the set of training frames. During the training of the blending network, the blending network may learn, for each set of training frames, how to combine first pixels from the modified non-reference training frames and second pixels from the reference training frame; the first pixels may be associated with pixel locations in the modified non-reference training frames exhibiting a lower degree of motion; and the second pixels may be associated with pixel locations in the modified non-reference training frames exhibiting a higher degree of motion. The single image may be received from the blending network, and the single image from the blending network may be stored, output, or used.

In a third embodiment, a method includes obtaining, using at least one processing device of an electronic device, multiple sets of training frames, where each set of training frames includes a reference training frame and multiple non-reference training frames. The method also includes generating, using the at least one processing device, synthetic motion maps. The method further includes, for each set of training frames, blending, using the at least one processing device, the reference training frame into the non-reference training frames based on at least one of the synthetic motion maps to generate modified non-reference training frames. In addition, the method includes training, using the at least one processing device, a blending network using the reference training frames and the modified non-reference training frames, where the blending network is trained to generate a single image based on multiple input frames. An apparatus may include at least one processing device configured to perform the method of the third embodiment. A non-transitory machine-readable medium may contain instructions that when executed cause at least one processor of an electronic device to perform the method of the third embodiment.

Any one or any combination of the following features may be used with the third embodiment. The synthetic motion maps may be generated, for each set of training frames, by generating a reference synthetic motion map; generating multiple temporary synthetic motion maps; and combining the reference synthetic motion map and the temporary synthetic motion maps to generate multiple final synthetic motion maps. For each set of training frames, the reference synthetic motion map may be used to generate the final synthetic motion maps for all non-reference training frames in the set of training frames, and different ones of the temporary synthetic motion maps may be used to generate different ones of the final synthetic motion maps for different non-reference training frames in the set of training frames. Each reference synthetic motion map may simulate motion appearing in all of the non-reference training frames in the associated set of training frames, and each temporary synthetic motion map may simulate motion appearing in one or a subset of the non-reference training frames in the associated set of training frames. During the training of the blending network, the blending network may learn, for each set of training frames, how to combine first pixels from the modified non-reference training frames and second pixels from the reference training frame; the first pixels may be associated with pixel locations in the modified non-reference training frames exhibiting a lower degree of motion; and the second pixels may be associated with pixel locations in the modified non-reference training frames exhibiting a higher degree of motion. The trained blending network may be deployed to user devices.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. §112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. §112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example pipeline for multi-frame processing (MFP) using machine learning-based deghosting trained with synthetic motion maps in accordance with this disclosure;

FIG. 3 illustrates an example process for generating training image frames for machine learning-based deghosting in accordance with this disclosure;

FIG. 4 illustrates an example process for creating synthetic motion maps for use in generating training image frames for machine learning-based deghosting in accordance with this disclosure;

FIG. 5 illustrates an example process for using synthetic motion maps to generate training image frames for machine learning-based deghosting in accordance with this disclosure;

FIG. 6 illustrates an example process for machine learning-based deghosting in accordance with this disclosure;

FIGS. 7A and 7B illustrate example results obtainable using MFP with machine learning-based deghosting trained with synthetic motion maps in accordance with this disclosure;

FIG. 8 illustrates an example method for training a blending network in accordance with this disclosure; and

FIG. 9 illustrates an example method for using a trained blending network in accordance with this disclosure.

### DETAILED DESCRIPTION

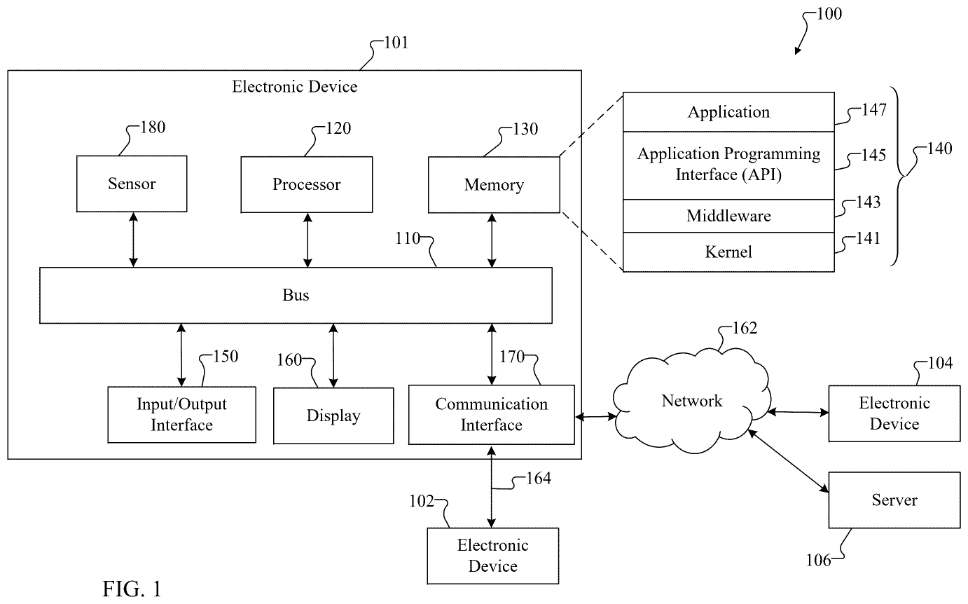

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, many mobile electronic devices, such as smartphones and tablet computers, include cameras that can be used to capture still and video images. In some cases, electronic devices can capture multiple image frames of the same scene, such as at different exposure levels, and blend the image frames to produce a high dynamic range (HDR) image of the scene. The HDR image generally has a larger dynamic range than any of the individual image frames. These techniques are often referred to as multi-frame processing (MFP) techniques. Among other things, blending the image frames to produce the HDR image can help to incorporate greater image details into both darker regions and brighter regions of the HDR image while reducing noise.

Unfortunately, various multi-frame processing techniques can suffer from a number of shortcomings. One of those shortcomings involves handling motion within scenes captured in image frames. In the real world, various objects within a scene can move, meaning an object can be captured at different locations within the scene in different image frames. Also, all objects within a scene may have some degree of motion due to hand/camera motion, which is common with image frames captured using handheld devices. Blending image frames that contain motion usually creates ghosting artifacts in areas of the scene where there is motion. Some blending approaches perform weighted blending of low dynamic range (LDR) image frames, where different weights are assigned to different pixels in the LDR image frames to be blended into a single HDR image. However, these approaches rely on accurately generating weights, which may be difficult to identify.

More-recent approaches have used machine learning models trained to blend multiple LDR images and generate high-quality HDR images. However, these machine learning models are trained using training datasets that only include image frames capturing static scenes. This results in a fundamental limitation since the lack of motion data during training can still allow the machine learning models to create ghosting artifacts during inferencing. Some variations of machine learning-based blending may attempt to incorporate deghosting into the blending operation itself. Unfortunately, because many training datasets include image frames captured of static scenes, obtaining a training dataset with motion in scenes may require additional resources, and ground truths (desired images to be produced by the machine learning-based blending) can be difficult or impossible to obtain. In addition, when blending and deghosting are performed in a single machine learning-based network, the network structure can become quite complicated, and the overall performance of the network can drop (such as when processing times increase).

This disclosure provides various techniques for multi-frame processing using machine learning-based deghosting trained with synthetic motion maps. For example, in some embodiments of this disclosure, multiple sets of training frames may be obtained, where each set of training frames may include a reference training frame and multiple non-reference training frames. Synthetic motion maps may be generated, and (for each set of training frames) the reference training frame may be blended into the non-reference training frames based on at least one of the synthetic motion maps to generate modified non-reference training frames. A blending network may be trained using the reference training frames and the modified non-reference training frames, where the blending network may be trained to generate a single image based on multiple input frames.

Also, in some embodiments of this disclosure, multiple image frames including a reference frame and multiple non-reference frames may be obtained, and multiple motion maps may be obtained. Each motion map may be based on a comparison between the reference frame and a respective one of the non-reference frames. Multiple modified non-reference frames may be generated based on the motion maps, where (for each non-reference frame) the non-reference frame and the reference frame may be blended based on the corresponding motion map associated with the non-reference frame. The reference frame and the modified non-reference frames may be provided to a blending network for use in generating a single image.

In this way, the described techniques can be used to train and use a machine learning model in the form of a blending network. During training, synthetic motion maps can be used to generate training image frames that contain simulated motion, while original image frames may be used as high-quality ground truths. As a result, the blending network can be trained more effectively to perform multi-frame blending or other multi-frame processing while significantly reducing or minimizing the presence of ghosting artifacts. Moreover, this enables training of the blending network without needing to obtain training datasets that contain real-world examples of motion in scenes. In addition, the blending network can be implemented separate from a deghosting network, which can be used to generate deghosting information (such as motion maps) used by the blending network during inferencing. As a result, this provides the ability to update the deghosting network without retraining the blending network from scratch using new training data.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to training or using machine learning models for MFP deghosting.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, train or use machine learning models for MFP deghosting. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to training or using machine learning models for MFP deghosting.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

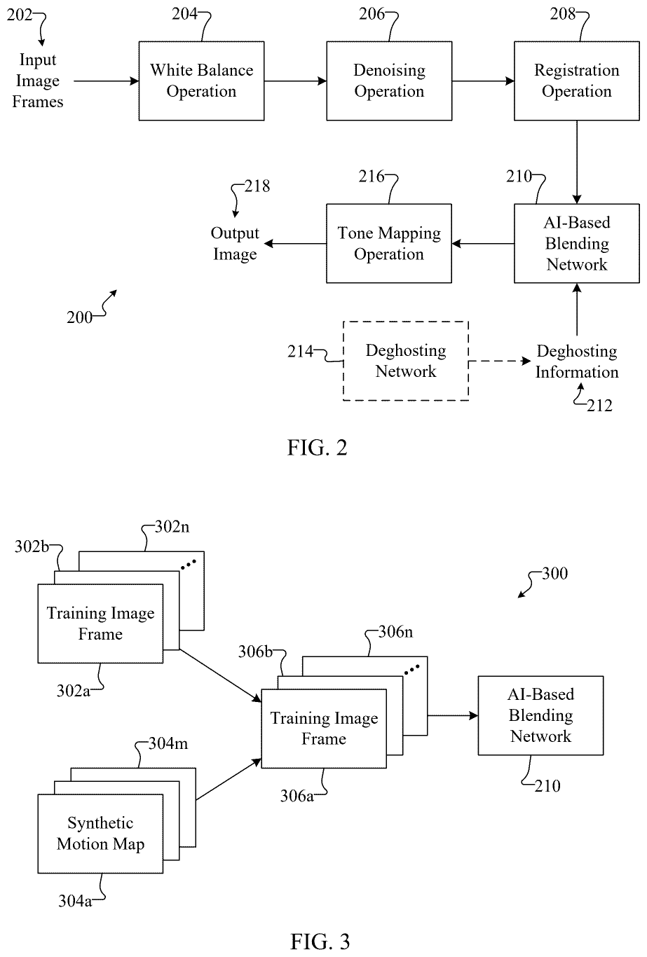

FIG. 2 illustrates an example pipeline 200 for multi-frame processing (MFP) using machine learning-based deghosting trained with synthetic motion maps in accordance with this disclosure. For ease of explanation, the pipeline 200 shown in FIG. 2 may be implemented on or supported by the electronic device 101 in the network configuration 100 of FIG. 1. However, the pipeline 200 shown in FIG. 2 could be used with any other suitable device(s) (such as the server 106) and in any other suitable system(s).

As shown in FIG. 2, the pipeline 200 generally receives and processes a set of input image frames 202. The set of input image frames 202 may include image frames captured in rapid succession or at substantially the same time. The input image frames 202 may be obtained from any suitable source(s), such as when the input image frames 202 are captured using at least one camera or other imaging sensor 180 of the electronic device 101 during an image capture operation. The set of input image frames 202 here may include any suitable number of input image frames 202. Each input image frame 202 can have any suitable resolution, such as up to fifty megapixels or more.

In some embodiments, the input image frames 202 represent raw image frames. Raw image frames typically refer to image frames that have undergone little if any processing after being captured. The availability of raw image frames can be useful in a number of circumstances since the raw image frames can be subsequently processed to achieve the creation of desired effects in output images. In many cases, for example, the input image frames 202 can have a wider dynamic range or a wider color gamut that is narrowed during image processing operations in order to produce still or video image frames suitable for display or other use. Each input image frame 202 can have any suitable format, such as a Bayer or other raw image format, a red-green-blue (RGB) image format, or a luma-chroma (YUV) image format.

In some embodiments, the input image frames 202 may include image frames captured using different capture conditions. The capture conditions can represent any suitable settings of the electronic device 101 or other device used to capture the input image frames 202. For example, the capture conditions may represent different exposure settings of the imaging sensor(s) 180 used to capture the input image frames 202, such as different exposure times or ISO settings. In multi-frame processing pipelines, for example, multiple input image frames 202 may be captured using different exposure settings so that portions of different input image frames 202 can be combined to produce an HDR output image or other blended image.

The input image frames 202 are processed using various operations in the pipeline 200. For example, each input image frame 202 may be provided to a white balance operation 204, which generally operates to perform white balance adjustment in order to modify the white balance of each input image frame 202. For example, the white balance operation 204 may adjust the colors in one, some, or all of the input image frames 202 so that the resulting adjusted input image frames have more-natural colors within each adjusted image frame and have more consistent colors across the adjusted image frames. The white balance operation 204 may use any suitable technique(s) for adjusting the white balance of image frames. Note, however, that this disclosure is not limited to any particular technique(s) for white balancing.

The adjusted image frames are provided to a denoising operation 206, which generally operates to process the image frames and remove noise from the image frames in order to generate filtered image frames. For example, the denoising operation 206 may be used to remove sampling, interpolation, and aliasing artifacts and noise in the image frames. The denoising operation 206 may also or alternatively be used to filter image data of the image frames in order to remove noise from object edges, which can help to provide cleaner edges to objects captured in the image frames. The denoising operation 206 may use any suitable technique(s) for filtering image data, such as spatial noise filtering. Note, however, that this disclosure is not limited to any particular technique(s) for denoising.

The filtered image frames are provided to a registration operation 208, which may also be referred to as an alignment operation. The registration operation 208 generally operates to modify one or more of the filtered image frames in order to generate aligned image frames. For example, the filtered image frames may undergo registration so that common features in different filtered image frames are at the same or substantially the same locations in the aligned image frames. In some embodiments, the registration operation 208 may select a reference image frame and modify one or more non-reference image frames so as to be aligned with the reference image frame. In some cases, for instance, the registration operation 208 generates a warp or alignment map for each non-reference image frame, where each warp or alignment map includes or is based on one or more motion vectors that identify how the position(s) of one or more specific features in the associated non-reference image frame should be altered in order to be in the position(s) of the same feature(s) in the reference image frame. Among other reasons, alignment may be needed in order to compensate for misalignment caused by the electronic device 101 moving or rotating in between image captures, which causes objects in the input image frames 202 to move or rotate slightly (as is common with handheld devices). The registration operation 208 may use any suitable technique(s) for image registration. In some embodiments, the aligned image frames can be aligned both geometrically and photometrically. In particular embodiments, the registration operation 208 can use global Oriented FAST and Rotated BRIEF (ORB) features and local features from a block search to identify how to align the image frames. Note, however, that this disclosure is not limited to any particular technique(s) for aligning image frames.

The aligned image frames are provided to an AI blending network 210. The AI blending network 210 also receives deghosting information 212, which represents information identifying where motion is detected in the input image frames 202 (if anywhere) and therefore where deghosting may be needed during blending. In some embodiments, the deghosting information 212 may include motion maps. As a particular example, the deghosting information 212 may include one motion map per non-reference image frame, where each motion map identifies motion captured in the corresponding non-reference image frame relative to the reference image frame. The deghosting information 212 may be provided by any suitable source(s), such as a deghosting network 214 that includes a machine learning model or other logic that identifies where motion may occur and/or where deghosting may be needed. Note that the deghosting information 212 need not be generated by the AI blending network 210 itself, which allows the AI blending network 210 to be implemented in a more-compact manner (compared to AI-based networks that perform both deghosting identification and blending). Moreover, this allows the deghosting network 214 to be modified or replaced without requiring retraining of the AI blending network 210.

The AI blending network 210 generally operates to blend the aligned image frames using the deghosting information 212 in order to generate a blended image. For example, the AI blending network 210 may be trained to combine different portions of the aligned image frames based on received motion maps. Among other things, this can allow the AI blending network 210 to retain portions of non-reference image frames that exhibit a lower degree of motion and to in-paint or otherwise incorporate portions of a reference image frame into portions of the non-reference frames that exhibit a higher degree of motion. The AI blending network 210 may also be trained to combine different portions of the aligned image frames so that the resulting blended image has improved image details in darker and/or brighter regions of a scene.

The AI blending network 210 may include any suitable machine learning-based architecture that can be trained to combine image frames, such as a convolution neural network (CNN) or other deep learning neural network. As described in more detail below, the AI blending network 210 can be trained at least partially using synthetic motion maps, which can be used to synthesize motion in training image frames. As a result, at least one training dataset for the AI blending network 210 can be obtained more easily and cost-effectively. Moreover, this allows the AI blending network 210 to be trained using training image frames that incorporate motion (rather than just capturing static scenes), which allows the AI blending network 210 to learn how to reduce or avoid ghosting artifacts more effectively.

The blended image generated by the AI blending network 210 can be provided to a tone mapping operation 216, which generally operates to adjust colors in the blended image. This can be useful or important in various applications, such as when generating HDR images. For example, since generating an HDR image often involves capturing multiple images of a scene using different exposures and combining the captured images to produce the HDR image, this type of processing can often result in the creation of unnatural tone within the HDR image. The tone mapping operation 216 can therefore use one or more color mappings to adjust the colors contained in the blended image. The output of the tone mapping operation 216 can represent an output image 218, which may represent a final image of the scene. In some cases, the output image 218 may undergo one or more additional post-processing operations (if desired) to produce a final image of the scene. The tone mapping operation 216 may use any suitable technique(s) to perform tone mapping, such as one or more global tone mapping techniques and/or one or more local tone mapping techniques. As a particular example, the tone mapping operation 216 may multiply each pixel of the blended image by a corresponding gain value to help ensure that the resulting output image 218 can be displayed appropriately. Note, however, that this disclosure is not limited to any particular technique(s) for tone mapping.

Although FIG. 2 illustrates one example of a pipeline 200 for MFP using machine learning-based deghosting trained with synthetic motion maps, various changes may be made to FIG. 2. For example, various components or operations in FIG. 2 may be combined, further subdivided, replicated, rearranged, or omitted according to particular needs. Also, various additional components or operations may be used in FIG. 2. Further, the pipeline 200 may be used to process any number of sets of input image frames 202 in order to generate any number of output images 218. In addition, the specific pipeline 200 described above is for illustration and explanation only. Various image processing pipelines and other pipelines have been developed, and additional pipelines are sure to be developed in the future. This disclosure is not limited to any specific implementation of an image processing pipeline. In general, the techniques for multi-frame processing using machine learning-based deghosting trained with synthetic motion maps that are described in this patent document may be used in any other image processing pipeline or other architecture.

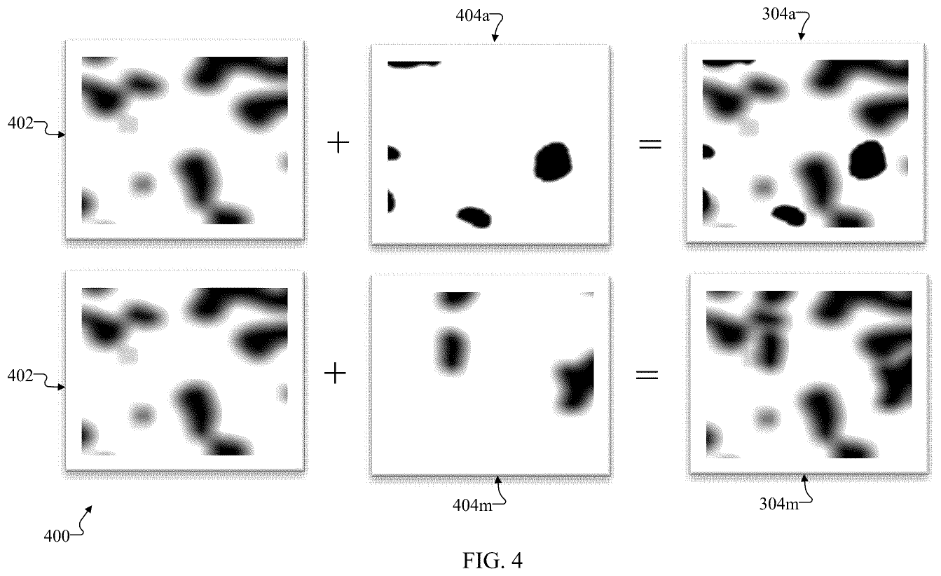

FIG. 3 illustrates an example process 300 for generating training image frames for machine learning-based deghosting in accordance with this disclosure. For ease of explanation, the process 300 shown in FIG. 3 may be implemented on or supported by the server 106 in the network configuration 100 of FIG. 1. However, the process 300 shown in FIG. 3 could be used with any other suitable device(s) (such as the electronic device 101) and in any other suitable system(s). Also, the process 300 shown in FIG. 3 may be used to generate training image frames for training the AI blending network 210 of FIG. 2. However, the process 300 shown in FIG. 3 may be used to generate training image frames for any other suitable blending network(s), which may be used in any other suitable pipeline(s) or architecture(s).

As shown in FIG. 3, the process 300 involves the use of a set of training image frames 302a-302n. Each of the training image frames 302a-302n represents an image frame to be processed by the AI blending network 210 in order to produce a blended image. The training image frames 302a-302n may, for example, represent a set of image frames capturing a static scene. In this example, the set of training image frames 302a-302n can include n image frames, where n is greater than two. The training image frames 302a-302n may be obtained from any suitable source(s) and in any suitable manner. In some embodiments, the training image frames 302a-302n may be obtained from a public or proprietary image dataset.

The process 300 also involves the use of a set of synthetic motion maps 304a-304m. Each motion map 304a-304m represents a map that identifies where motion occurs in an associated one of the training image frames 302a-302n. However, the motion maps 304a-304m need not be based on actual motion but on simulated motion. Thus, the motion maps 304a-304m here are referred to as “synthetic” since they can be artificially-generated (at least in part) and applied to various ones of the training image frames 302a-302n. In this example, the synthetic motion maps 304a-304m can include m image frames, where m=n−1 in some cases. This is because one of the training image frames 302a-302n (such as the first training image frame 302a in the set) may be treated as a reference image frame, so there may be m non-reference training image frames and m associated synthetic motion maps.

The set of synthetic motion maps 304a-304m can be applied to the set of training image frames 302a-302n in order to produce a new set of training image frames 306a-306n, where at least most of the training image frames 306a-306n represent modified versions of the training image frames 302a-302n. For example, assume that the training image frame 302a is selected as the reference image frame, so remaining training image frames 302b-302n are non-reference image frames. Each of the non-reference training image frames 302b-302n can be combined with the reference image frame 302a based on a corresponding one of the synthetic motion maps 304a-304m, which results in the generation of a corresponding modified image frame that can be used as one of the training image frames 306b-306n. This can be performed for all m synthetic motion maps 304a-304m and all m non-reference training image frames 302b-302n in order to produce m training image frames 306b-306n. The reference image frame 302a may be used as the training image frame 306a, meaning the reference image frame 302a may be unmodified (although one or more modifications could be done to the reference image frame 302a in order to produce the training image frame 306a). This results in the creation of a new set of n training image frames 306a-306n.

This approach can be repeated for any number of sets of training image frames 302a-302n in order to create any number of sets of training image frames 306a-306n. Note that each set of training image frames 302a-302n and each associated set of training image frames 306a-306n can include any suitable number of image frames, and the number of image frames can vary across different sets of image frames. The resulting sets of training image frames 306a-306n can be used to train the AI blending network 210. During the training, for each set of training image frames 306a-306n, one or more of the training image frames 302a-302n (such as the reference image frame in the original set of training image frame 302a-302n) may be used as a ground truth.

In this way, the AI blending network 210 is not trained simply using images of static scenes. Rather, the AI blending network 210 is trained using image frames that simulate the existence of motion within the scenes. This allows the AI blending network 210 to be trained to more effectively perform deghosting while blending sets of image frames.

Although FIG. 3 illustrates one example of a process 300 for generating training image frames for machine learning-based deghosting, various changes may be made to FIG. 3. For example, various components or operations in FIG. 3 may be combined, further subdivided, replicated, rearranged, or omitted according to particular needs. Also, various additional components or operations may be used in FIG. 3. In addition, the process 300 may be used to process any number of sets of training image frames in order to generate any number of modified sets of training image frames.

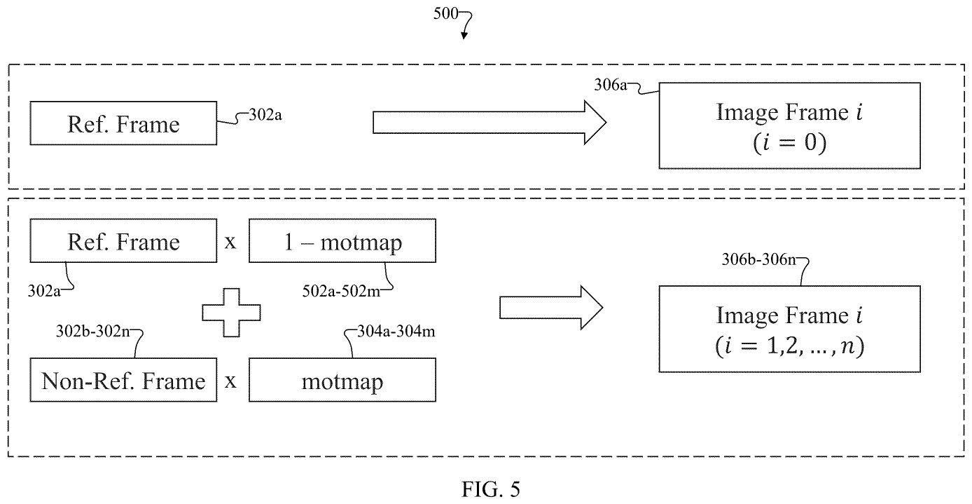

FIG. 4 illustrates an example process 400 for creating synthetic motion maps 304a-304m for use in generating training image frames 306a-306n for machine learning-based deghosting in accordance with this disclosure. For ease of explanation, the process 400 shown in FIG. 4 may be implemented on or supported by the server 106 in the network configuration 100 of FIG. 1. However, the process 400 shown in FIG. 4 could be used with any other suitable device(s) (such as the electronic device 101) and in any other suitable system(s). Also, the process 400 shown in FIG. 4 may be used to generate training image frames for training the AI blending network 210 of FIG. 2. However, the process 400 shown in FIG. 4 may be used to generate training image frames for any other suitable blending network(s), which may be used in any other suitable pipeline(s) or architecture(s).

As shown in FIG. 4, for a given set of training image frames 302a-302n, a single reference synthetic motion map 402 may be generated. The reference synthetic motion map 402 can represent first motion to be applied to all of the non-reference image frames 302b-302n in the set of training image frames 302a-302n. The reference synthetic motion map 402 can be combined with different temporary synthetic motion maps 404a-404m to generate final synthetic motion maps 304a-304m. Here, each temporary synthetic motion map 404a-404m can represent second motion to be applied to an individual one (or a subset) of the non-reference image frames 302b-302n in the set of training image frames 302a-302n. As a result, the first motion defined in the reference synthetic motion map 402 can be used to generate all of the final synthetic motion maps 304a-304m. The second motion defined in different ones of the temporary synthetic motion maps 404a-404m can be used to generate different ones of the final synthetic motion maps 304a-304m.

The reference synthetic motion map 402 and the temporary synthetic motion maps 404a-404m may be generated in any suitable manner. In some embodiments, for example, each synthetic motion map 402, 404a-404m may be created based on random shape generation. Also, each synthetic motion map 402, 404a-404m may be scaled to include values within a specified range, such as between zero and one (inclusive) where zero denotes a higher degree of motion and one denotes a lower degree of motion. This type of scale may match the scale used in motion maps produced during inferencing, such as motion maps generated by the deghosting network 214 and forming at least part of the deghosting information 212. Note, however, that other techniques can be used for synthetic motion map generation, as long as the scale of the resulting synthetic motion maps is suitable for use.

As a specific example, each synthetic motion map 402, 404a-404m may be generated in the following manner, which produces a random mask with soft edges and varying levels of opacity. A random noise image can be created, such as by randomly using integers ranging from zero to 255 as pixel values in the random noise image. The random noise image can have dimensions that match the dimensions (such as width and height) of a corresponding training image 302a-302n. The random noise image can be blurred, such as by using a Gaussian filter with a randomly-chosen sigma value, to generate a filtered image. This can help to smooth out the noise and create more gradual transitions between pixel values. The filtered image can be thresholded using a specified threshold value to create a binary mask, where pixel values in the filtered image above the threshold value are given a first value (such as 255) in the binary mask and pixel values in the filtered image below the threshold value are given a second value (such as zero) in the binary mask. The binary mask can be subjected to one or more morphological operations to remove outliers, such as very small regions having a size below a specified threshold. The binary mask can be blurred again, such as by using a Gaussian filter or other filter having a randomly-chosen kernel size and sigma value. This filtering can help to soften edges of the binary mask to mimic soft edges observed in typical motion maps. In some cases, the kernel size and the sigma value can be determined experimentally. The blurred mask can be scaled, such as to values between zero and one (inclusive), to generate the synthetic motion map 402, 404a-404m. In some cases, the reference synthetic motion map 402 and the temporary synthetic motion maps 404a-404m can all be generated in this manner, but each synthetic motion map 402, 404a-404m can be generated using a unique random seed.

By using this process 400, each of the final synthetic motion maps 304a-304m can include one or more random shapes that are defined by (i) the reference synthetic motion map 402 and (ii) one of the temporary synthetic motion maps 404a-404m. The reference synthetic motion map 402 is common across all final synthetic motion maps 304a-304m for a given set of training image frames 302a-302n, while the temporary synthetic motion maps 404a-404m are used for individual image frames or subsets of image frames in the set of training image frames 302a-302n.

Although FIG. 4 illustrates one example of a process 400 for creating synthetic motion maps 304a-304m for use in generating training image frames 306a-306n for machine learning-based deghosting, various changes may be made to FIG. 4. For example, various components or operations in FIG. 4 may be combined, further subdivided, replicated, rearranged, or omitted according to particular needs. Also, various additional components or operations may be used in FIG. 4. Further, synthetic motion maps may be generated in any other suitable manner. In addition, the process 400 may be used to create any number of sets of synthetic motion maps for use with any number of sets of training image frames.

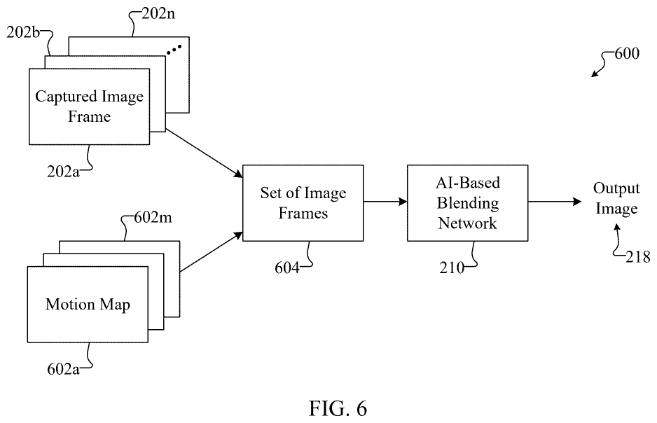

FIG. 5 illustrates an example process 500 for using synthetic motion maps 304a-304m to generate training image frames for machine learning-based deghosting in accordance with this disclosure. For ease of explanation, the process 500 shown in FIG. 5 may be implemented on or supported by the server 106 in the network configuration 100 of FIG. 1. However, the process 500 shown in FIG. 5 could be used with any other suitable device(s) (such as the electronic device 101) and in any other suitable system(s). Also, the process 500 shown in FIG. 5 may be used to generate training image frames for training the AI blending network 210 of FIG. 2. However, the process 500 shown in FIG. 5 may be used to generate training image frames for any other suitable blending network(s), which may be used in any other suitable pipeline(s) or architecture(s).

As shown in FIG. 5, a reference image frame in this example is assumed to represent the training image frame 302a. Note, however, that another image frame in the set of training image frames 302a-302n may be selected as the reference frame. The reference frame 302a may be used as the training image frame 306a in the set of training image frames 306a-306n. For example, the reference frame 302a may be unmodified, so the training image frame 302a can be used as the training image frame 306a without changes.

For the other (non-reference) training image frames 302b-302n, the synthetic motion maps 304a-304m can be applied to those training image frames 302b-302n in order to generate the remaining training image frames 306b-306n. In this example, for each training image frame 302b-302n, the training image frame 302b-302 is multiplied by the corresponding synthetic motion map 304a-304m. This can be done on a pixel-by-pixel basis, meaning each pixel value of the training image frame 302b-302 is multiplied by an associated pixel value in the corresponding synthetic motion map 304a-304m. For each training image frame 302b-302n, the reference frame 302a is multiplied by an inverse synthetic motion map 502a-502m, where the pixel values of the inverse synthetic motion map 502a-502m are calculated by subtracting each pixel value of the corresponding synthetic motion map 304a-304m from one. Thus, for example, each inverse synthetic motion map 502a-502m can include a pixel value of zero where the corresponding synthetic motion map 304a-304m includes a pixel value of one, and each inverse synthetic motion map 502a-502m can include a pixel value of one where the corresponding synthetic motion map 304a-304m includes a pixel value of zero. The products of the two multiplications are added together to form one of the training image frames 306b-306n.

This approach can effectively use the synthetic motion maps 304a-304m to combine some pixels from the reference frame 302a and some pixels from the corresponding non-reference frames 302b-302n, thereby creating the appearance of some form of motion within the training image frames 306a-306n. As a result, the training image frames 306a-306n can be used to train the AI blending network 210 to combine image frames while also reducing or minimizing ghosting artifacts. For example, the AI blending network 210 can learn how to combine first pixels from (modified) non-reference training frames 306b-306m and second pixels from a reference training frame 306a, where (i) the first pixels are associated with pixel locations in the modified non-reference training frames 306b-306m exhibiting a lower degree of motion and (ii) the second pixels are associated with pixel locations in the modified non-reference training frames 306b-306m exhibiting a higher degree of motion. During this training, each new set of training image frames 306a-306n can be used for training the AI blending network 210, while one or more of the original training image frames 302a-302n (such as the reference training frame 306a) can be used as one or more ground truths during the training. Once trained, the AI blending network 210 can be deployed, such as for use during inferencing as part of an image processing pipeline (like the pipeline 200).

Although FIG. 5 illustrates one example of a process 500 for using synthetic motion maps 304a-304m to generate training image frames for machine learning-based deghosting, various changes may be made to FIG. 5. For example, various components or operations in FIG. 5 may be combined, further subdivided, replicated, rearranged, or omitted according to particular needs. Also, various additional components or operations may be used in FIG. 5. Further, the process 500 assumes that a motion map uses zero to denote a higher degree of motion and one to denote a lower degree of motion. However, the opposite approach may be taken, in which case (i) the reference image frame 302a may be multiplied by the motion maps and (ii) the non-reference image frames 302b-302n may be multiplied by the inverse motion maps. In addition, the process 500 may be used to process any number of sets of training image frames in order to generate any number of modified sets of training image frames.

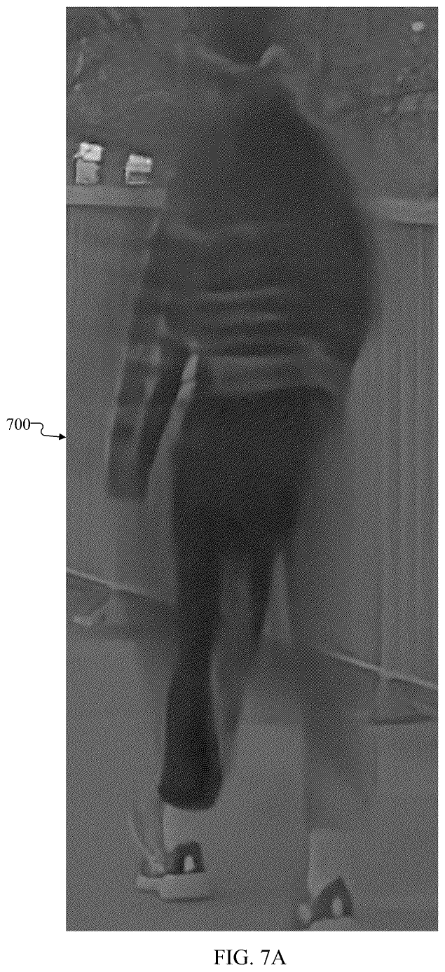

FIG. 6 illustrates an example process 600 for machine learning-based deghosting in accordance with this disclosure. For ease of explanation, the process 600 shown in FIG. 6 may be implemented on or supported by the electronic device 101 in the network configuration 100 of FIG. 1. However, the process 600 shown in FIG. 6 could be used with any other suitable device(s) (such as the server 106) and in any other suitable system(s).

As shown in FIG. 6, once the AI blending network 210 has been trained and deployed for use, the AI blending network 210 can be used during inferencing. For example, a set of captured image frames 202a-202n can be obtained, such as in the manner described above with respect to FIG. 2. Also, a set of motion maps 602a-602m can be obtained, such as from the deghosting network 214 as at least part of the deghosting information 212. Each motion map 602a-602m can be determined by comparing a reference image frame (such as the image frame 202a) in the set of captured image frames 202a-202n with a corresponding non-reference image frame (such as a corresponding image frame 202b-202n) in the set of captured image frames 202a-202n. In some case, each motion map 602a-602m can be scaled to include values within a specified range, such as between zero and one (inclusive) where zero denotes a higher degree of motion and one denotes a lower degree of motion. Each motion map 602a-602m can have a resolution that matches the resolution of the corresponding non-reference frame 202b-202n.

In some embodiments, the reference frame can be selected from among the set of captured image frames 202a-202n based on overall measure of motion in each captured image frame 202a-202n, such as by identifying and selecting the captured image frame with the smallest global motion percentage. For example, for each captured image frame 202a-202n, a metric can be calculated per image block with a specified window size, and potential motion pixels can be selected and estimated in each block (such as by using phase correlation) and further refined based on a set threshold. The reference frame can be selected as the captured image frame 202a-202n having the lowest global motion percentage among all of the captured image frames 202a-202n. The remaining captured image frames 202a-202n are considered non-reference frames. Note that this approach may optionally be used as part of the process 300 to select the reference training image frame from the set of training image frames 302a-302n.

Once the reference frame is selected, the captured image frames 202a-202n may be sorted so that the reference frame has an index of zero and the non-reference frames have an index ranging from one to n. Note, however, that this sorting may not actually need to be performed by an electronic device and may simply be used here as a matter of convenience. The reference frame and the non-reference frames can be used to generate a new set of image frames 604, such as by using the same or similar process as the process 500 shown in FIG. 5. That is, the selected reference frame (possibly unmodified) from the captured image frames 202a-202n may be included as a reference frame in the new set of image frames 604. The reference frame can be combined with the non-reference frames from the captured image frames 202a-202n based on the corresponding motion maps 602a-602m to produce modified image frames included in the new set of image frames 604. The resulting new set of image frames 604 can be provided to the AI blending network 210, which can blend or otherwise combine the new set of image frames 604 to produce an output image 218.

Again, it can be seen here that the motion maps 602a-602m can be generated by the deghosting network 214 using any suitable technique(s), and the motion maps 602a-602m can be used as part of the process to create image frames for processing by the AI blending network 210. Moreover, the AI blending network 210 can use any suitable technique to blend or otherwise combine the image data from the image frames 604 provided to the AI blending network 210. Thus, compared to other AI-based blending techniques, this approach separates the identification of the motion maps from the network structure performing the blending during inferencing. Among other things, this provides the ability to update the deghosting network 214 without retraining the AI blending network 210 from scratch.

Although FIG. 6 illustrates one example of a process 600 for machine learning-based deghosting, various changes may be made to FIG. 6. For example, various components or operations in FIG. 6 may be combined, further subdivided, replicated, rearranged, or omitted according to particular needs. Also, various additional components or operations may be used in FIG. 6. In addition, the process 600 may be used to process any number of sets of captured image frames in order to generate any number of output images.

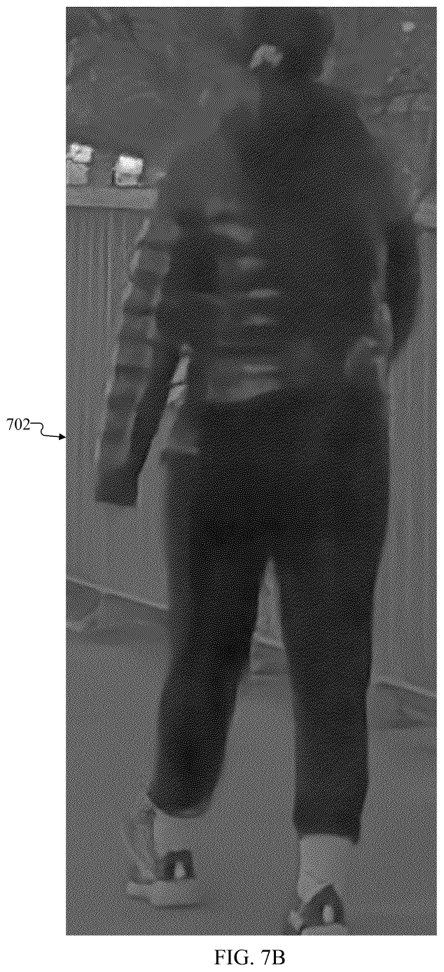

FIGS. 7A and 7B illustrate example results obtainable using MFP with machine learning-based deghosting trained with synthetic motion maps in accordance with this disclosure. More specifically, FIG. 7A illustrates an example output image 700 that could be generated using an AI blending network that was trained using image frames capturing static scenes only. The scene here includes a person walking away in a darker setting. As can be seen here, the output image 700 suffers from a large amount of ghosting, which is common in multi-frame blending (particularly in darker scenes).

FIG. 7B illustrates an example output image 702 generated using the AI blending network 210 that was trained as discussed above. As can be seen here, the output image 702 captures the same scene as in FIG. 7A but is significantly clearer and suffers from significantly less ghosting. Among other reasons, this is because the AI blending network 210 can be trained using training image frames and synthetic motion maps as described above. This can result in significant improvements in the quality of the output images generated by the AI blending network 210.

Although FIGS. 7A and 7B illustrate one example of results obtainable using MFP with machine learning-based deghosting trained with synthetic motion maps, various changes may be made to FIGS. 7A and 7B. For example, FIGS. 7A and 7B are merely meant to illustrate one example of a type of benefit that might be obtained using the techniques of this disclosure. The specific results that are obtained in any given situation can vary based on the circumstances (including the specific scenes being imaged) and based on the specific implementation of the techniques described in this disclosure.

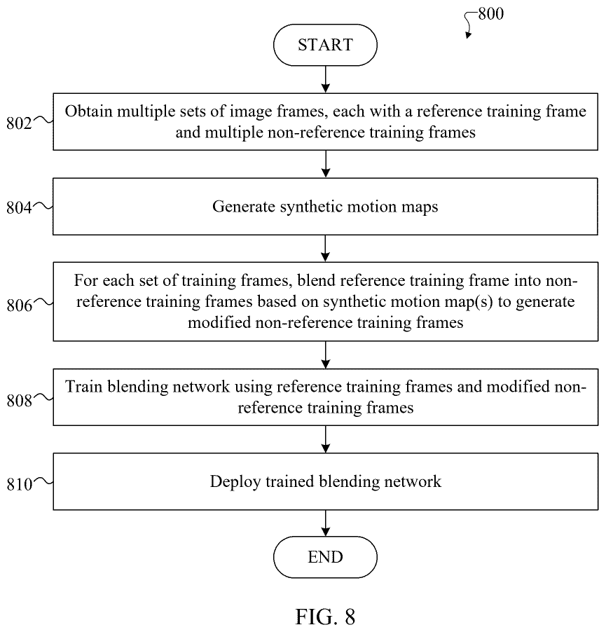

FIG. 8 illustrates an example method 800 for training a blending network in accordance with this disclosure. For ease of explanation, the method 800 shown in FIG. 8 is described as being performed using the server 106 in the network configuration 100 shown in FIG. 1, where the server 106 may implement the processes 300-500 shown in FIGS. 3-5. However, the method 800 may be performed using any other suitable device(s) (such as the electronic device 101) and in any other suitable system(s), and the method 800 may be implemented using any other suitable process(es) or architecture(s) designed in accordance with this disclosure.

As shown in FIG. 8, multiple sets of training image frames are obtained at step 802. This may include, for example, the processor 120 of the server 106 obtaining multiple sets of training image frames 302a-302n. Each set of training image frames includes a reference training image frame (such as a reference frame 302a) and multiple non-reference training image frames (such as non-reference frames 302b-302n).

Synthetic motion maps are generated at step 804. This may include, for example, the processor 120 of the server 106 generating multiple synthetic motion maps 304a-304m for each set of training image frames 302a-302n. As a particular example, the processor 120 of the server 106 may, for each set of training frames 302a-302n, generate a reference synthetic motion map 402, generate multiple temporary synthetic motion maps 404a-404m, and combine the reference synthetic motion map 402 and the temporary synthetic motion maps 404a-404m. Each reference synthetic motion map 402 can be used to generate the synthetic motion maps 304a-304m for all non-reference frames 302b-302n in the corresponding set of training frames 302a-302n, and different ones of the temporary synthetic motion maps 404a-404m can be used to generate different ones of the synthetic motion maps 304a-304m for different non-reference training frames 302b-302n in the corresponding set of training frames 302a-302n. Each reference synthetic motion map 402 can simulate motion appearing in all of the non-reference frames 302b-302n in the associated set of training frames 302a-302n, and each temporary synthetic motion map 404a-404m can simulate motion appearing in one or a subset (but not all) of the non-reference frames 302b-302n in the associated set of training frames 302a-302n.

For each set of training frames, the reference training frame is blended into the non-reference training frames based on one or more of the synthetic motion maps to generate modified non-reference training frames at step 806. This may include, for example, the processor 120 of the server 106, for each set of training image frames 302a-302n, multiplying pixel values of the non-reference frames 302b-302n by pixel values of the corresponding synthetic motion maps 304a-304m on a pixel-by-pixel basis, multiplying pixel values of the reference frame 302a by the pixel values of corresponding inverse synthetic motion maps 502a-502m on a pixel-by-pixel basis, and adding the products on a pixel-by-pixel basis to generate modified training frames 306b-306n. In some cases, for each set of training image frames 302a-302n, the reference frame 302a may be used unmodified as the training image frame 306a.

A blending network is trained using the reference training frames and the modified non-reference training frames at step 808. This may include, for example, the processor 120 of the server 106 using a machine learning training process to train the AI blending network 210 to blend or otherwise combine each set of training image frames 306a-306n into a single output image 218. During the training, one or more of the original training image frames 302a-302n from each original set may be used as a ground truth. As part of the training process, differences between the output images 218 generated by the AI blending network 210 can be compared to the ground truths in order to calculate a loss for the AI blending network 210, and weights or other parameters of the AI blending network 210 can be adjusted with the goal of reducing the loss. The training can be repeated over any number of training epochs using any suitable number of training image frame sets, and the training may continue until the loss reaches a suitably-low value or some other criterion or criteria have been met (such as a specified amount of time has elapsed or a specified number of training epochs have been completed).

During the training, the AI blending network 210 learns how to combine pixels from different image frames within each set of training image frames 306a-306n. For example, the AI blending network 210 can learn how to combine first pixels from the modified non-reference training frames 306b-306n and second pixels from the reference training frame 306a in each set of training image frames 306a-306n. Here, for each set, the first pixels can be associated with pixel locations in the modified non-reference training frames 306b-306n exhibiting a lower degree of motion. The second pixels can be associated with pixel locations in the modified non-reference training frames 306b-306n exhibiting a higher degree of motion, so pixel values for those pixel locations may be obtained from the reference training frame 306a of the set.

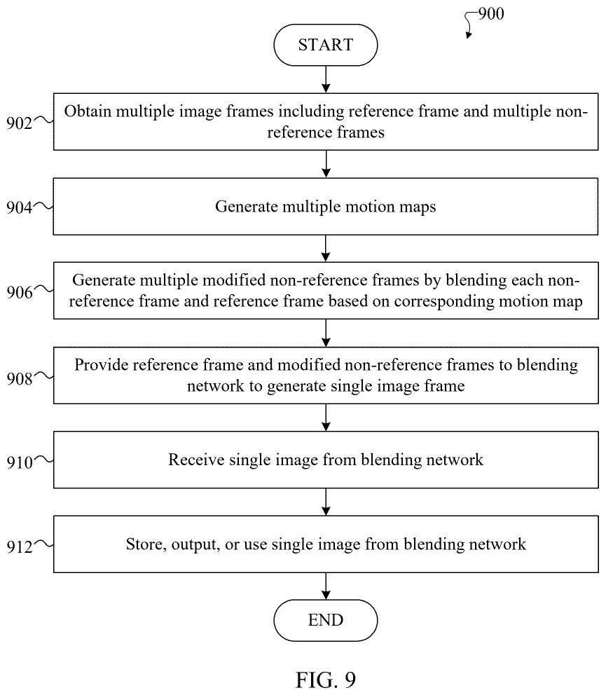

The trained blending network is deployed at step 810. This may include, for example, the processor 120 of the server 106 providing the trained AI blending network 210 to one or more user devices, such as one or more mobile smartphones or other electronic devices 101. At that point, the trained AI blending network 210 may be used by the one or more user devices to process sets of captured image frames. One example of that processing is shown in FIG. 9 and described below. Note, however, that the trained AI blending network 210 may be used in any other suitable manner. For instance, the trained AI blending network 210 may be deployed for use by the server 106 itself or by another server.

Although FIG. 8 illustrates one example of a method 800 for training a blending network 210, various changes may be made to FIG. 8. For example, while shown as a series of steps, various steps in FIG. 8 may overlap, occur in parallel, occur in a different order, or occur any number of times (including zero times).

FIG. 9 illustrates an example method 900 for using a trained blending network 210 in accordance with this disclosure. For ease of explanation, the method 900 shown in FIG. 9 is described as being performed using the electronic device 101 in the network configuration 100 shown in FIG. 1, where the electronic device 101 may implement the process 600 shown in FIG. 6. However, the method 900 may be performed using any other suitable device(s) (such as the server 106) and in any other suitable system(s), and the method 900 may be implemented using any other suitable process(es) or architecture(s) designed in accordance with this disclosure.

As shown in FIG. 9, multiple image frames including a reference frame and multiple non-reference frames are obtained at step 902. This may include, for example, the processor 120 of the electronic device 101 obtaining multiple captured image frames 202a-202n, such as image frames captured using one or more imaging sensors 180 of the electronic device 101. As noted above, the reference frame (such as the captured image frame 202a) may represent the image frame having the smallest global motion percentage or other smallest amount of motion. The other image frames in the set (such as the captured image frames 202b-202n) can represent non-reference frames.

Multiple motion maps are obtained at step 904. This may include, for example, the processor 120 of the electronic device 101 generating or otherwise obtaining motion maps 602a-602m, such as by using the deghosting network 214. Each motion map 602a-602m can be based on a comparison between the reference frame 202a and a respective one of the non-reference frames 202b-202n. As a result, each motion map 602a-602m can identify motion captured in one of the non-reference frames 202b-202n relative to the reference frame 202a.

Multiple modified non-reference frames are generated at step 906. This may include, for example, the processor 120 of the electronic device 101 blending each non-reference frame 202b-202n and the reference frame 202a based on the corresponding motion map 602a-602m. For instance, the processor 120 of the electronic device 101 may, for each non-reference frame 202b-202n, select a first group of pixels from the non-reference frame 202b-202n based on the corresponding motion map 602a-602m, select a second group of pixels from the reference frame 202a based on the corresponding motion map 602a-602m, and combine the first group of pixels and the second group of pixels to generate a respective one of the modified non-reference frames. The first group of pixels can be associated with pixel locations in the non-reference frame 202b-202n that exhibit a lower degree of motion, and the second group of pixels can be associated with pixel locations in the non-reference frame 202b-202n that exhibit a higher degree of motion. As a particular example, this may include the processor 120 of the electronic device 101 multiplying pixel values of the non-reference frames 202b-202n by pixel values of the corresponding motion maps 602a-602m on a pixel-by-pixel basis, multiplying pixel values of the reference frame 202a by the pixel values of corresponding inverse synthetic motion maps 502a-502m on a pixel-by-pixel basis, and adding the products on a pixel-by-pixel basis to generate the modified non-reference frames in a new set of image frames 604. In some cases, the reference frame 202a may be used unmodified in the set of image frames 604.

The reference frame and the modified non-reference frames are provided to a trained blending network in order to generate a single image at step 908. This may include, for example, the processor 120 of the electronic device 101 providing the set of image frames 604 to a trained AI blending network 210, which may have been previously trained as discussed above with reference to FIG. 8. The trained AI blending network 210 can process the set of image frames 604 and generate a blended image, where the blended image includes little or no ghosting artifacts.

The single image can be received from the trained blending network at step 910 and stored, output, or used in some manner at step 912. This may include, for example, the processor 120 of the electronic device 101 receiving the blended image from the trained AI blending network 210. This may also include the processor 120 of the electronic device 101 performing one or more post-processing operations, such as tone mapping, to produce a final output image 218. The output image 218 may be displayed on the display 160 of the electronic device 101, saved to a camera roll stored in a memory 130 of the electronic device 101, or attached to a text message, email, or other communication to be transmitted from the electronic device 101. Of course, the output image 218 could be used in any other or additional manner.

Although FIG. 9 illustrates one example of a method 900 for using a trained blending network 210, various changes may be made to FIG. 9. For example, while shown as a series of steps, various steps in FIG. 9 may overlap, occur in parallel, occur in a different order, or occur any number of times (including zero times).

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, multiple image frames comprising a reference frame and multiple non-reference frames;
obtaining, using the at least one processing device, multiple motion maps, each motion map based on a comparison between the reference frame and a respective one of the non-reference frames;
generating, using the at least one processing device, multiple modified non-reference frames based on the motion maps, wherein generating the modified non-reference frames comprises, for each non-reference frame, blending the non-reference frame and the reference frame based on the corresponding motion map associated with the non-reference frame; and
providing, using the at least one processing device, the reference frame and the modified non-reference frames to a blending network to generate a single image.

2. The method of claim 1, wherein, for each non-reference frame, blending the non-reference frame and the reference frame comprises:
selecting a first group of pixels from the non-reference frame based on the corresponding motion map, the first group of pixels associated with pixel locations in the non-reference frame that exhibit a lower degree of motion;
selecting a second group of pixels from the reference frame based on the corresponding motion map, the second group of pixels associated with pixel locations in the non-reference frame that exhibit a higher degree of motion; and
combining the first group of pixels and the second group of pixels to generate a respective one of the modified non-reference frames.

3. The method of claim 1, wherein the blending network is trained by:
obtaining multiple sets of training frames, each set of training frames comprising a reference training frame and multiple non-reference training frames;
generating synthetic motion maps;
for each set of training frames, blending the reference training frame into the non-reference training frames based on at least one of the synthetic motion maps to generate modified non-reference training frames; and
training the blending network using the reference training frames and the modified non-reference training frames.

4. The method of claim 3, wherein generating the synthetic motion maps comprises, for each set of training frames:
generating a reference synthetic motion map;
generating multiple temporary synthetic motion maps; and
combining the reference synthetic motion map and the temporary synthetic motion maps to generate multiple final synthetic motion maps.

5. The method of claim 4, wherein, for each set of training frames:
the reference synthetic motion map is used to generate the final synthetic motion maps for all non-reference training frames in the set of training frames; and
different ones of the temporary synthetic motion maps are used to generate different ones of the final synthetic motion maps for different non-reference training frames in the set of training frames.

6. The method of claim 3, wherein, during the training of the blending network:
the blending network learns, for each set of training frames, how to combine first pixels from the modified non-reference training frames and second pixels from the reference training frame;
the first pixels are associated with pixel locations in the modified non-reference training frames exhibiting a lower degree of motion; and
the second pixels are associated with pixel locations in the modified non-reference training frames exhibiting a higher degree of motion.

7. The method of claim 1, further comprising:
receiving the single image from the blending network; and
storing, outputting, or using the single image from the blending network.

8. An electronic device comprising:
at least one processing device configured to:
obtain multiple image frames comprising a reference frame and multiple non-reference frames;
obtain multiple motion maps, each motion map based on a comparison between the reference frame and a respective one of the non-reference frames;
generate multiple modified non-reference frames based on the motion maps, wherein, to generate the modified non-reference frames, the at least one processing device is configured, for each non-reference frame, to blend the non-reference frame and the reference frame based on the corresponding motion map associated with the non-reference frame; and
provide the reference frame and the modified non-reference frames to a blending network to generate a single image.

9. The electronic device of claim 8, wherein, for each non-reference frame, to blend the non-reference frame and the reference frame, the at least one processing device is configured to:
select a first group of pixels from the non-reference frame based on the corresponding motion map, the first group of pixels associated with pixel locations in the non-reference frame that exhibit a lower degree of motion;
select a second group of pixels from the reference frame based on the corresponding motion map, the second group of pixels associated with pixel locations in the non-reference frame that exhibit a higher degree of motion; and
combine the first group of pixels and the second group of pixels to generate a respective one of the modified non-reference frames.

10. The electronic device of claim 8, wherein the blending network is trained by:
obtaining multiple sets of training frames, each set of training frames comprising a reference training frame and multiple non-reference training frames;
generating synthetic motion maps;
for each set of training frames, blending the reference training frame into the non-reference training frames based on at least one of the synthetic motion maps to generate modified non-reference training frames; and
training the blending network using the reference training frames and the modified non-reference training frames.

11. The electronic device of claim 10, wherein the synthetic motion maps are generated by, for each set of training frames:
generating a reference synthetic motion map;
generating multiple temporary synthetic motion maps; and
combining the reference synthetic motion map and the temporary synthetic motion maps to generate multiple final synthetic motion maps.

12. The electronic device of claim 11, wherein, for each set of training frames:
the reference synthetic motion map is used to generate the final synthetic motion maps for all non-reference training frames in the set of training frames; and
different ones of the temporary synthetic motion maps are used to generate different ones of the final synthetic motion maps for different non-reference training frames in the set of training frames.

13. The electronic device of claim 10, wherein, during the training of the blending network:
the blending network learns, for each set of training frames, how to combine first pixels from the modified non-reference training frames and second pixels from the reference training frame;
the first pixels are associated with pixel locations in the modified non-reference training frames exhibiting a lower degree of motion; and
the second pixels are associated with pixel locations in the modified non-reference training frames exhibiting a higher degree of motion.

14. The electronic device of claim 8, wherein the at least one processing device is further configured to:
receive the single image from the blending network; and
store, output, or use the single image from the blending network.

15. A method comprising:
obtaining, using at least one processing device of an electronic device, multiple sets of training frames, each set of training frames comprising a reference training frame and multiple non-reference training frames;
generating, using the at least one processing device, synthetic motion maps;
for each set of training frames, blending, using the at least one processing device, the reference training frame into the non-reference training frames based on at least one of the synthetic motion maps to generate modified non-reference training frames; and
training, using the at least one processing device, a blending network using the reference training frames and the modified non-reference training frames, the blending network trained to generate a single image based on multiple input frames.

16. The method of claim 15, wherein generating the synthetic motion maps comprises, for each set of training frames:
generating a reference synthetic motion map;
generating multiple temporary synthetic motion maps; and
combining the reference synthetic motion map and the temporary synthetic motion maps to generate multiple final synthetic motion maps.

17. The method of claim 16, wherein, for each set of training frames:
the reference synthetic motion map is used to generate the final synthetic motion maps for all non-reference training frames in the set of training frames; and
different ones of the temporary synthetic motion maps are used to generate different ones of the final synthetic motion maps for different non-reference training frames in the set of training frames.

18. The method of claim 16, wherein:
each reference synthetic motion map simulates motion appearing in all of the non-reference training frames in the associated set of training frames; and
each temporary synthetic motion map simulates motion appearing in one or a subset of the non-reference training frames in the associated set of training frames.

19. The method of claim 15, wherein, during the training of the blending network:
the blending network learns, for each set of training frames, how to combine first pixels from the modified non-reference training frames and second pixels from the reference training frame;
the first pixels are associated with pixel locations in the modified non-reference training frames exhibiting a lower degree of motion; and
the second pixels are associated with pixel locations in the modified non-reference training frames exhibiting a higher degree of motion.

20. The method of claim 15, further comprising:
deploying the trained blending network to user devices.
